(19) United States
(12) Patent Application Publication
(10) Pub. No.: US 2021/0245346 A1
(43) Pub. Date: Aug. 12, 2021

(54) METHOD FOR SECURING A COMPONENT TO A SUBSTRATE

(71) Applicant: HILTI AKTIENGESELLSCHAFT, Schaan (LI)

(72) Inventors: Ulrich ROSENBAUM, Wangs (CH); Klaudia LICHTENBERG, Nenzing (AT); Kurt OEHRI, Schaan (LI); Rutvika Kirankumar ACHARYA, Feldkirch (AT)

(21) Appl. No.: 16/972,652

(22) PCT Filed: Jul. 2, 2019
(86) PCT No.: PCT/EP2019/067736

§ 371 Date: Dec. 7, 2020

(30) Foreign Application Priority Data
Jul. 11, 2018 (EP) 18182880.7

(51) Int. Cl. B25C 7/00; F16B 15/02; E04B 1/76

(52) U.S. Cl. CPC B25C 7/00; E04B 1/7633; F16B 15/02

(57) ABSTRACT

In a method for securing a component, a nail having a nail shank and a nail head is provided, a sleeve is arranged on the nail shank, a driving-in element and a guide channel are provided, the nail head and the sleeve are arranged in the guide channel such that a peripheral gap is formed between the nail head and the guide channel, the driving-in element is driven through the guide channel toward the nail head in order to move the nail in a driving-in direction toward the substrate, the sleeve is compressed between the nail shank, the guide channel and the nail head while the nail moves toward the substrate, and a portion of the sleeve is pressed into the peripheral gap between the nail head and the guide channel.

The present invention relates to a method for securing a layered component to a substrate.

It is required in the building sector for an insulating material as an in particular layered component to be fastened to walls or ceilings of buildings as a substrate. The insulating material generally serves as thermal insulation for the wall or ceiling of the building and is fastened on the outer side of the wall or ceiling. For this purpose, fastening elements are fastened by setting elements, for example nails, to the wall or ceiling. The fastening elements made of plastic comprise a hollow shaft and a disk which bears on an outer side of the insulating material after fastening, the shaft being arranged within a through-hole in the insulating material. The hollow shaft comprises a shaft bottom having a passage for the setting element, with the result that the fastening element can be indirectly fastened by means of the setting element to the setting object.

To drive the setting element into the substrate, use is made of a setting device having a driving-in element, which is guided in a guide channel, and a drive for the driving-in element. An amount of energy which the drive applies to the driving-in element is customarily tailored to the setting element, the fastening element and the substrate, wherein excess energy is at least to some extent dissipated in the fastening element and/or in the setting device, and the fastening element or the setting device is mechanically loaded and damaged under certain circumstances.

The object of the present invention consists in providing a fastening method in which mechanical loading on a fastening element and/or on a setting device is reduced.

The object is achieved in a method for securing a component to a substrate, in which a nail having a nail shank and a nail head is provided, wherein the nail head has a head diameter which projects beyond the nail shank, a sleeve is arranged on the nail shank, a driving-in element and a guide channel are provided, wherein the guide channel has an inside diameter which exceeds the head diameter, the nail head and the sleeve are arranged in the guide channel such that a peripheral gap is formed between the nail head and the guide channel, the driving-in element is driven through the guide channel toward the nail head in order to move the nail in a driving-in direction toward the substrate, the sleeve is compressed between the nail shank, the guide channel and the nail head while the nail moves toward the substrate, and a portion of the sleeve is pressed into the peripheral gap between the nail head and the guide channel. Here, excess energy of the nail that occurs under certain circumstances is dissipated in the sleeve such that mechanical loading on a device which drives the driving-in element is reduced. The component preferably comprises an insulating material and/or the substrate preferably comprises a wall or ceiling of a building.

An advantageous embodiment is characterized in that a portion of the sleeve is pressed through the peripheral gap between the nail head and the guide channel.

An advantageous embodiment is characterized in that the driving-in element comprises a plunger which has a plunger diameter, wherein the inside diameter exceeds the plunger diameter such that a further peripheral gap is formed between the plunger and the guide channel, wherein a portion of the sleeve is pressed into the further peripheral gap between the plunger and the guide channel.

An advantageous embodiment is characterized in that the sleeve is plastically deformed during the compression between the nail shank, the guide channel and the nail head.

An advantageous embodiment is characterized in that the sleeve completely fills a cavity between the nail shank, the guide channel and the nail head during the compression between the nail shank, the guide channel and the nail head.

An advantageous embodiment is characterized in that the sleeve is plastically deformed during the pressing of a portion of the sleeve into the peripheral gap between the nail head and the guide channel. The pressing of a portion of the sleeve into the peripheral gap between the nail head and the guide channel preferably comprises a massive forming, articularly preferably an extrusion, of the sleeve.

An advantageous embodiment is characterized in that the sleeve is plastically deformed during the pressing of a portion of the sleeve into the further peripheral gap between the plunger and the guide channel. The pressing of a portion of the sleeve into the further peripheral gap between the plunger and the guide channel preferably comprises a massive forming, particularly preferably an extrusion, of the sleeve.

An advantageous embodiment is characterized in that the sleeve is elastically deformed during the pressing of a portion of the sleeve into the peripheral gap between the nail head and the guide channel.

An advantageous embodiment is characterized in that the sleeve is elastically deformed during the pressing of a portion of the sleeve into the further peripheral gap between the plunger and the guide channel.

An advantageous embodiment is characterized in that a fastening element is provided, having a disk for holding the component, a hollow shaft which projects from the disk and which has a shaft bottom, wherein the shaft bottom preferably has a passage for the nail shank, and the sleeve, wherein the sleeve projects from the shaft bottom, wherein the guide channel is inserted into the hollow shaft until the guide channel bears against the shaft bottom and the sleeve is arranged in the guide channel.

An advantageous embodiment is characterized in that a power-operated setting device is provided, having the guide channel, the driving-in element and a drive for the driving-in element, wherein the guide channel projects beyond the driving-in element in all positions of the driving-in element in the driving-in direction.

An advantageous embodiment is characterized in that the sleeve consists substantially of plastic, preferably thermoplastic.

An advantageous embodiment is characterized in that the nail, the driving-in element and/or the guide channel consist/consists substantially of a metal or an alloy, preferably steel.

Exemplary embodiments of the invention will be described in more detail below with reference to the appended drawings, in which:

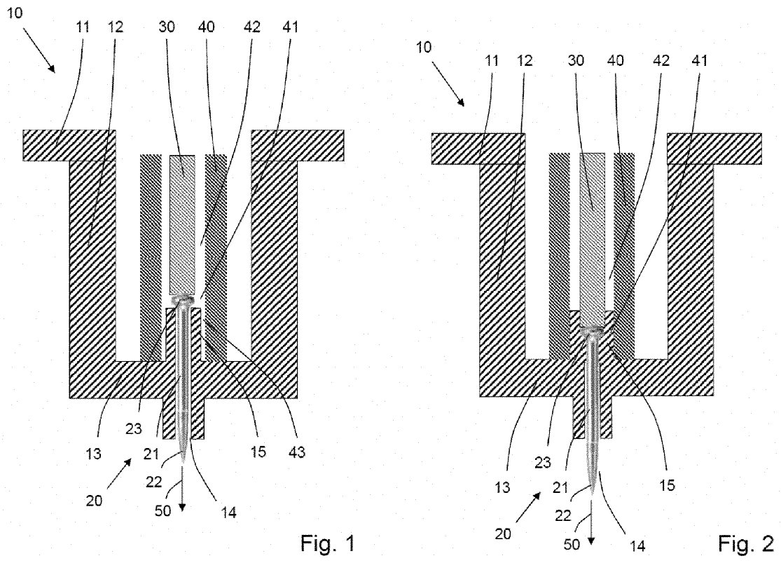

FIG. 1 shows a partial longitudinal section of a fastening element at the start of a fastening method, and

FIG. 2 shows a partial longitudinal section of the fastening element shown in FIG. 1 at the end of the fastening method.

FIG. 1 partially illustrates a fastening element 10 and a nail 20 along with a driving-in element 30 and a guide channel 40 in a longitudinal section.

The fastening element 10 has a disk 11 for holding a component (not shown) against a substrate (not shown either), a hollow shaft 12 which projects from the disk 11 and which has a shaft bottom 13, and a sleeve 15 which projects from the shaft bottom 13. The shaft bottom 13 has a passage 14 for the nail 20. The sleeve 15, preferably the entire fastening element 10, consists substantially of a thermoplastic.

The nail 20 comprises a nail shank 21 with a nail point 22, and a nail head 23 having a head diameter which projects beyond the nail shank 21. The nail 20 is premounted in the passage 14 such that the sleeve 15 is arranged on the nail shank 21 and surrounds the nail shank 21. The nail 20 consists substantially of steel.

The driving-in element 30 and the guide channel 40 likewise consist substantially of steel and are part of a setting device (not illustrated further) which additionally comprises a drive for the driving-in element. The driving-in element 30 consists of a plunger having a plunger diameter which is approximately equal to the head diameter of the nail head 23.

The guide channel 40 has an inside diameter which exceeds the head diameter of the nail head 23 and the plunger diameter of the driving-in element 30, with the result that a peripheral gap 41 is formed on the one hand between the nail head 23 and the guide channel 40, and a further peripheral gap 42 is formed on the other hand between the driving-in element 30 and the guide channel 40. The peripheral gap 41 and/or the further peripheral gap 42 each have/has a gap width which is preferably between 0.5 mm and 1.5 mm, for example 0.8 mm. The guide channel 40 projects beyond the driving-in element 30 in all positions of the driving-in element in a driving-in direction 50 such that the fastening element 10 is not damaged by the nail 20 when the nail is driven in the fastening direction 50 into the substrate.

At the start of a fastening method, the guide channel 40 is inserted into the hollow shaft 12 until the guide channel 40 bears against the shaft bottom 13, with the result that the sleeve 15 and the nail head 23 are arranged in the guide channel. A cavity 43 is formed here between the nail shank 21, the guide channel 40 and the nail head 23, in which cavity the sleeve 15 is situated. As soon as the setting device (not shown) is triggered, the drive of the setting device drives the driving-in element 30 through the guide channel 40 toward the nail head 23 in order to move the nail 20 in the driving-in direction 50 toward the substrate and to drive it into the substrate.

FIG. 2 illustrates the fastening element 10, the nail 20, the driving-in element 30 and the guide channel 40 at the end of the fastening method. The movement of the nail 20 with the nail head 23 toward the substrate has caused the sleeve 15 to be compressed between the nail shank 21, the guide channel 40 and the nail head 23. The sleeve 15 is plastically deformed and completely fills the cavity 43 between the nail shank 21, the guide channel 40 and the nail head 23. Furthermore, a portion of the sleeve 15 has been pressed through the peripheral gap 41 between the nail head 23 and the guide channel 40 into the further peripheral gap 42 between the driving-in element 30 and the guide channel 40. Here, the sleeve 15 has also been plastically deformed, in particular extruded. Part of the deformation of the sleeve 15 is an elastic deformation, with the result that the sleeve 15 bears with a prestress against the nail head 23 from outside and engages around the nail head 23 when the driving-in element 30 is withdrawn from the hollow shaft 12 of the fastening element 10. This force- and form-fitting engagement improves the fastening quality under certain circumstances.

The invention has been described using the example of a method for fastening in particular an insulating material to a wall or ceiling of a building. However, it should be noted that the invention is also suitable for other purposes.

1. A method for securing a component to a substrate, the method comprising:
providing a nail having a nail shank and a nail head, wherein the nail head has a head diameter which projects beyond the nail shank,
arranging a sleeve on the nail shank,
providing a driving-in element and a guide channel, wherein the guide channel has an inside diameter which exceeds the head diameter,
arranging the nail head and the sleeve in the guide channel such that a peripheral gap is formed between the nail head and the guide channel,
driving the driving-in element through the guide channel toward the nail head in order to move the nail in a driving-in direction toward the substrate,
compressing the sleeve between the nail shank, the guide channel and the nail head while the nail moves toward the substrate, and
pressing a portion of the sleeve into the peripheral gap between the nail head and the guide channel.

2. The method as claimed in claim 1, further comprising:
pressing a portion of the sleeve through the peripheral gap between the nail head and the guide channel.

3. The method as claimed in claim 1, wherein the driving-in element comprises a plunger which has a plunger diameter, wherein the inside diameter of the guide channel exceeds the plunger diameter such that a further peripheral gap is formed between the plunger and the guide channel, the method further comprising:
pressing a portion of the sleeve into the further peripheral gap between the plunger and the guide channel.

4. The method as claimed in claim 1, wherein the sleeve is plastically deformed during the compression between the nail shank, the guide channel and the nail head.

5. The method as claimed in claim 1, wherein the sleeve completely fills a cavity between the nail shank, the guide channel and the nail head during the compression between the nail shank, the guide channel and the nail head.

6. The method as claimed in claim 1, wherein the sleeve is plastically deformed during the pressing of a portion of the sleeve into the peripheral gap between the nail head and the guide channel.

7. The method as claimed in claim 6, wherein the pressing of a portion of the sleeve into the peripheral gap between the nail head and the guide channel comprises a massive forming of the sleeve.

8. The method as claimed in claim 3, wherein the sleeve is plastically deformed during the pressing of a portion of the sleeve into the further peripheral gap between the plunger and the guide channel.

9. The method as claimed in claim 8, wherein the pressing of a portion of the sleeve into the further peripheral gap between the plunger and the guide channel comprises a massive forming of the sleeve.

10. The method as claimed in claim 1, wherein the sleeve is elastically deformed during the pressing of a portion of the sleeve into the peripheral gap between the nail head and the guide channel.

11. The method as claimed in claim 3, wherein the sleeve is elastically deformed during the pressing of a portion of the sleeve into the further peripheral gap between the plunger and the guide channel.

12. The method as claimed in claim 1, further comprising:
providing a fastening element having a disk for holding the component, a hollow shaft which projects from the disk and which has a shaft bottom, wherein the shaft bottom has in particular a passage for the nail shank, and the sleeve, wherein the sleeve projects from the shaft bottom,
inserting the guide channel into the hollow shaft until the guide channel bears against the shaft bottom and the sleeve is arranged in the guide channel.

13. The method as claimed in claim 1, further comprising:
providing a power-operated setting device, having the guide channel, the driving-in element and a drive for the driving-in element, wherein the guide channel projects beyond the driving-in element in all positions of the driving-in element in the driving-in direction.

14. The method as claimed in claim 1, wherein the sleeve consists substantially of plastic.

15. The method as claimed in claim 1, wherein the nail, the driving-in element and/or the guide channel consist/consists substantially of a metal or an alloy.

16. The method of claim 7, wherein pressing the portion of the sleeve into the peripheral gap comprises an extrusion of the sleeve.

17. The method of claim 9, wherein pressing the portion of the sleeve into the further peripheral gap comprises an extrusion of the sleeve.

18. The method of claim 14, wherein the sleeve consists substantially of a thermoplastic.

19. The method of claim 15, wherein the nail, the driving-in element and/or the guide channel consist/consists substantially of steel.

20. The method as claimed in claim 2, wherein the driving-in element comprises a plunger which has a plunger diameter, wherein the inside diameter of the guide channel exceeds the plunger diameter such that a further peripheral gap is formed between the plunger and the guide channel, the method further comprising:
pressing a portion of the sleeve into the further peripheral gap between the plunger and the guide channel.
